(19) United States
(12) Patent Application Publication
(10) Pub. No.: US 2020/0202042 A1
(43) Pub. Date: Jun. 25, 2020

(54) POWER SUPPLY CONTROL CIRCUIT WITH CONFIGURATION VALIDATION

(71) Applicant: TEXAS INSTRUMENTS INCORPORATED, Dallas, TX (US)

(72) Inventors: Matthew John Ascher SCHURMANN, Manchester, NH (US); Preetam Charan Anand TADEPARTHY, Bengaluru (IN); Kuang-Yao CHENG, Bedford, NH (US)

(21) Appl. No.: 16/227,050

(22) Filed: Dec. 20, 2018

(51) Int. Cl. G06F 21/81; G06F 1/28

(52) U.S. Cl. CPC G06F 21/81; G06F 1/28

(57) ABSTRACT

A power supply control circuit includes serial communication circuitry, non-volatile memory, and a controller circuit. The serial communication circuitry is configured to receive configuration information. The configuration information includes a data structure containing validation information identifying a controller. The non-volatile memory is configured to store the configuration information, and to store identification information that identifies the power supply control circuit. The controller circuit is configured to compare the validation information to the identification information, and to apply the configuration information to configure the power supply control circuit responsive the comparison indicating that the validation information is the same as the identification information.

### BACKGROUND

A switch-mode power supply is an electronic circuit that converts an input direct current (DC) supply voltage into one or more DC output voltages that are higher or lower in magnitude than the input DC supply voltage. A switch-mode power supply that generates an output voltage lower than the input voltage is termed a buck or step-down converter. A switch-mode power supply that generates an output voltage higher than the input voltage is termed a boost or step-up converter.

Some switch-mode power supply topologies include a drive/power transistor coupled at a switch node to an energy storage inductor/transformer. Electrical energy is transferred through the energy storage inductor/transformer to a load by alternately opening and closing the switch as a function of a switching signal. The amount of electrical energy transferred to the load is a function of the ON/OFF duty cycle of the switch and the frequency of the switching signal. Switch-mode power supplies are widely used to power electronic devices, particularly battery powered devices, such as portable cellular phones, laptop computers, and other electronic systems in which efficient use of power is desirable.

### SUMMARY

A power supply control circuit that reduces the likelihood of generating an unintended voltage, due to misconfiguration, by validating the information received to configure operation of the power supply control circuit is disclosed herein. In one example, a power supply control circuit includes serial communication circuitry, non-volatile memory, and a controller circuit. The serial communication circuitry is configured to receive configuration information. The configuration information includes a data structure containing validation information identifying a power supply controller. The non-volatile memory is configured to store the configuration information, and to store identification information that identifies the power supply control circuit. The controller circuit is configured to identify the validation information in the configuration information, retrieve the identification information from the non-volatile memory, compare the validation information to the identification information, determine whether the configuration information is intended to be used by the power supply control circuit, and apply the configuration information to configure the power supply control circuit based on a determination that the configuration information is intended to be used by the power supply control circuit.

In another example, a method includes receiving, by a power supply control circuit, via a serial communication interface, configuration information to configure power supply control circuitry of the power supply control circuit. The configuration information includes a data structure containing validation information that identifies a power supply controller. Identification information stored in non-volatile memory of the power supply control circuit at manufacture is retrieved by the power supply control circuit. The validation information is compared to the identification information by the power supply control circuit, and based on the comparison, a determination of whether the configuration information is intended to be used by the power supply control circuit is made. The configuration information is rejected for use in the power supply control, by the power supply control circuit, based on the determination indicating that the configuration information is not intended to be used by the power supply control circuit.

In a further example, a server system includes a power supply circuit and server circuitry. The power supply circuit is configured to generate a power supply voltage. The power supply circuit includes a power supply control circuit. The server circuitry is powered by the power supply circuit. The power supply control circuit includes serial communication circuitry, non-volatile memory, and a controller circuit. The serial communication circuitry is configured to receive configuration information. The configuration information includes a data structure containing validation information that identifies a power supply controller corresponding to the configuration information. The non-volatile memory is configured to store the configuration information, and to store identification information that identifies the power supply control circuit. The controller circuit is configured to compare the validation information to the identification information, and to apply the configuration information to configure the power supply control circuit responsive to the comparison indicating that the power supply control circuit is the power supply controller identified by the configuration information.

### BRIEF DESCRIPTION OF THE DRAWINGS

For a detailed description of various examples, reference will now be made to the accompanying drawings in which:

FIG. 1 shows a block diagram for a system that includes multiple power supplies in accordance with the present disclosure;

FIG. 2 shows a block diagram for a power supply control circuit that includes configuration validation in accordance with the present disclosure;

FIG. 3 shows an example of configuration information suitable for use in a power supply control circuit in accordance with the present disclosure;

FIG. 4 shows a block diagram for a validation circuit in accordance with the present disclosure;

FIG. 5 shows a flow diagram for a method for validating configuration information in a power supply control circuit in accordance with the present disclosure; and

FIG. 6 shows a block diagram for an example controller circuit provided in some implementations of a power supply control circuit in accordance with the present disclosure.

### DETAILED DESCRIPTION

Certain terms have been used throughout this description and claims to refer to particular system components. As one skilled in the art will appreciate, different parties may refer to a component by different names. This document does not intend to distinguish between components that differ in name but not function. In this disclosure and claims, the terms “including” and “comprising” are used in an open-ended fashion, and thus should be interpreted to mean “including, but not limited to . . . .” The recitation “based on” is intended to mean “based at least in part on.” Therefore, if X is based on Y, X may be a function of Y and any number of other factors.

Many electronic systems apply multiple power supply voltages to power the various components and sub-systems that make up the system. For example, in a system, a first sub-system is powered by 5 volts, a second sub-system is powered by 3.3 volts, a third sub-system is powered by 1.8 volts, and a fourth sub-system is powered by 1 volt. The system may include a different power supply circuit to generate each of the different voltages. To simplify power supply design and manufacturing, power supply control circuits (i.e., power supply controllers) may be designed to be application configurable, such that a given power supply control circuit can be configured to operate in a variety of power supply circuits without redesigning the power supply control circuit. For example, a complex system like a server board, may have 10 or more different power supply rails, each with different operational parameters (output voltage, protection limits, etc.). Each of multiple instances of a given power supply control circuit can be configured to provide one of the power supply rails. Thus, a system may include multiple instances of the same power supply control circuit, each of which is programmed with different configuration information.

Configuration of a power supply control circuit includes generation of the configuration information (e.g., a configuration file) using a computer-based configuration tool, downloading the configuration information to the power supply control circuit, and storing the configuration in the power supply control circuit. When power is applied to the power supply control circuit, the power supply control circuit reads the stored configuration information from memory and applies the configuration information to adjust the operation of the power supply control circuitry within the power supply control circuit.

When multiple sets of configuration information (e.g., multiple configuration files) are available to be downloaded to a power supply control circuit, as when a system includes multiple power supply control circuits that are to be configured differently, configuration information intended for one power supply control circuit may be mistakenly downloaded into a different power supply control circuit. Because each set of configuration information is internally consistent and functional with multiple power supply control circuits, configuration information can be downloaded to a wrong power supply control circuit with no immediate indication of the error. However, when the power supply control circuit applies the wrong control information, the voltages produced by the power supply may damage the circuitry of the system (e.g., the circuitry of the power supply or the circuitry powered by the power supply) because the circuitry is intended to operate with a different power supply voltage. For example, a system might include 5 volt, 3.3 volt, 1.8 volt, and 1 volt power rails. The configuration information for both the 5 volt and 1 volt power supplies are internally consistent, and functional in any of the power supply control circuits. However, if the configuration information intended for the 5 volt power supply is loaded into the power supply control circuit for the 1 volt power supply, the circuitry powered by the 1 volt power supply may be damaged.

Thus, some power supply control circuits exhibit a technical problem in that the power supply control circuit accepts and implements configuration information that causes the power supply control circuit to generate an unintended voltage, which in turn damages the power supply or the load circuits coupled to the power supply. The power supply control circuits and configuration methods disclosed herein provide a technical solution to the problem of circuit damage caused by providing unintended configuration information to a power supply control circuit. The technical solution includes providing, in the power supply control circuit, a controller circuit, such as a state machine or microcontroller, that determines whether received configuration information is intended for use in the power supply control circuit, and inhibits application of received configuration information by the power supply control circuit if configuration information is not intended for use in the power supply control circuit.

In the power supply control circuits and the configuration methods disclosed herein, the configuration information includes a data structure, such as a header or footer, which contains validation information. The validation information includes parameters that identify a power supply control circuit for which the configuration information is intended. The power supply control circuit compares the parameters of the validation information to identification information stored in the power supply control circuit at the time of manufacture. If the validation information matches the identification information stored in the power supply control circuit, then the power supply control circuit applies the configuration information. If the validation information does not match the identification information stored in the power supply control circuit, then the power supply control circuit rejects the configuration information.

Some implementations of the power supply control circuit may also measure the voltage or current present on an input terminal of the power supply control circuit to identify connection of a component to the power supply control circuit. The power supply control circuit analyzes the configuration information to determine whether the configuration information indicates that a component should be connected to the input terminal. If no component is detected connected to the input terminal, and the configuration information indicates that component should be connected to the input terminal, then the power supply control circuit rejects the configuration information. Similarly, if a component is detected connected to the input terminal, and the configuration information indicates that no component should be connected to the input terminal, then the power supply control circuit rejects the configuration information.

The power supply control circuits disclosed herein provide a technical solution to the problem of circuit damage caused by erroneous power supply output voltages. The technical solution includes providing a controller circuit in the power supply control circuit that compares validation information, received with the configuration information, to internal parameters of the power supply control circuit to determine whether the configuration information is intended for use by power supply control circuit. Furthermore, in some implementations of the power supply control circuit, the controller circuit measures voltage or current at a terminal of the power supply control circuit to determine a parameter of the power supply circuit in which the power supply control circuit is operating. Based on the parameter, the controller circuit determines whether the configuration information is consistent with the power supply circuit in which power supply control circuit is operating. Thus, the power supply control circuits of the present disclosure provide an improvement to power supply technology by preventing misconfiguration of a power supply control circuit and preventing damage to power supply or load circuitry caused by the misconfiguration.

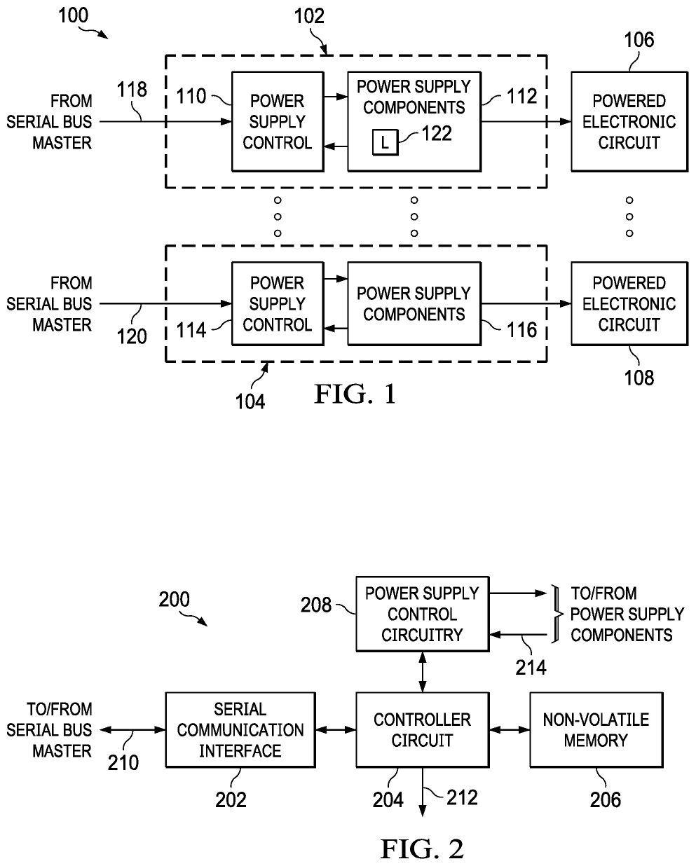

FIG. 1 shows a block diagram for a system 100 that includes multiple power supplies in accordance with the present disclosure. The system 100 may be a server board, a network switch, or other system that includes circuitry powered by multiple power supplies. The system 100 includes a power supply 102, a power supply 104, electronic circuitry 106, and electronic circuitry 108. The electronic circuitry 106 is powered by the power supply 102, and the electronic circuitry 108 is powered by the power supply 104. The voltage generated by the power supply 102 that is needed to power the electronic circuitry 106, may be different from the voltage generated by the power supply 104 that is needed to power the electronic circuitry 108. The electronic circuitry 106 and the electronic circuitry 108 may include various electronic components, such as microprocessors, memory, network processors, etc. Implementations of the system 100 may include more than two power supplies and more than two electronic circuits powered by the power supplies.

The power supply 102 includes a power supply control circuit 110 and power supply components 112 coupled to the power supply control circuit 110. The power supply components 112 may include one or more power transistors, an inductor 122, capacitors, and/or other components. The power supply control circuit 110 generates pulses that activate the power transistor(s) to charge and discharge the inductor 122 as needed to produce the voltage needed to power the electronic circuitry 106.

Similarly, the power supply 104 includes a power supply control circuit 114 and power supply components 116 coupled to the power supply control circuit 114. The power supply components 116 may include one or more power transistors, an inductor, capacitors, and/or other components. The power supply control circuit 114 generates pulses that activate the power transistor(s) to charge and discharge the inductor as needed to produce the voltage needed to power the electronic circuitry 108.

In some implementations of the system 100, the power supply control circuit 110 and the power supply control circuit 114 are instances of a same power supply control circuit. In other implementations, the power supply control circuit 110 and the power supply control circuit 114 are different types of power supply control circuits. The power supply control circuit 110 and the power supply control circuit 114 are respectively configured to operate by configuration information 118 and configuration information 120 received via a serial bus from a serial bus master. The configuration information controls various parameters of the power supply control circuit including, for example, switching frequency, number of operation phases (for a multi-phase power supply), maximum power supply output current, power supply output voltage etc. If the output voltage generated by the power supply 102 is intended to be different from the output voltage generated by the power supply 104, then the configuration information 118 will be different from the configuration information 120.

In some implementations of the system 100, the configuration information 118 may be compatible with both the power supply control circuit 110 and the power supply control circuit 114. In such an implementation, loading the configuration information 118 into the power supply control circuit 114 may cause the power supply 104 to produce an unintended output voltage that is inoperable with or damaging to the electronic circuitry 108 and/or the power supply components 116. Implementations of the power supply control circuit 110 and the power supply control circuit 114 disclosed herein include a controller circuit that inhibits configuration of the power supply control circuit with configuration information that is not intended for use in the power supply control circuit.

FIG. 2 shows a block diagram for a power supply control circuit 200 that includes configuration validation in accordance with the present disclosure. The power supply control circuit 200 is an implementation of the power supply control circuit 110 or the power supply control circuit 114. The power supply control circuit 200 includes a serial communication interface 202, a controller circuit 204, non-volatile memory 206, and power supply control circuitry 208. The serial communication interface 202 includes circuitry that provides communication, via a serial bus, with a serial bus master device external to the serial communication interface 202. For example, the serial communication interface 202 may include circuitry that implements an Inter-Integrated Circuit (I²C) interface or a variant of an I²C interface, such as a system management bus (SMBus) interface or a power management bus (PMBus) interface that allows communication via a corresponding serial bus 210. The power supply control circuit 200 receives configuration information for configuring the power supply control circuitry 208 via the serial bus 210 and the serial communication interface 202.

The controller circuit 204 is coupled to the serial communication interface 202. The controller circuit 204 includes circuitry that examines the configuration information received by the serial communication interface 202, and determines whether the configuration information is intended to be used by the power supply control circuit 200 to configure the power supply control circuitry 208. The controller circuit 204 may include a microcontroller or a state machine that processes the configuration information.

The non-volatile memory 206 stores the configuration information received via the serial bus 210 and the serial communication interface 202 for use in configuring the power supply control circuitry 208 at each power-up of the power supply control circuit 200. The non-volatile memory 206 may include electrically-erasable programmable read-only memory (EEPROM), FLASH memory, or other non-volatile memory technology. The controller circuit 204 may control transfer of configuration information received via the serial communication interface 202 to the non-volatile memory 206. For example, if the controller circuit 204 determines that received configuration information is not intended for use with the power supply control circuit 200, then the controller circuit 204 may reject the configuration information by preventing the configuration information from being written to the non-volatile memory 206 and preventing the configuration information from being applied in the power supply control circuitry 208. The controller circuit 204 may also activate an alert signal 212 if the controller circuit 204 determines that received configuration information 210 is not intended for use in the power supply control circuit 200.

The power supply control circuitry 208 includes pulse generation circuitry that produces pulses to drive external power supply components (e.g., the power supply components 112) to generate a specified power supply output voltage. The power supply control circuitry 208 receives feedback from the external power supply components 112 that the power supply control circuitry 208 applies to regulate the power supply output voltage.

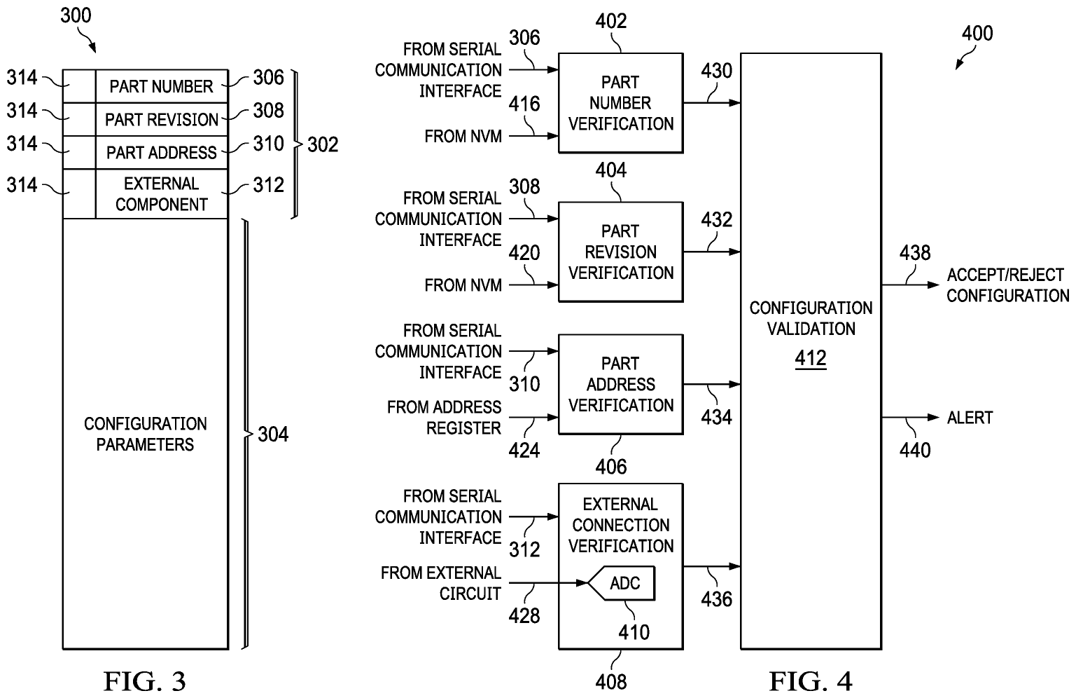

FIG. 3 shows an example of configuration information 300 received by the power supply control circuit 200. The configuration information 300 includes validation information 302 and configuration parameters 304. The configuration parameters 304 are applied to configure the power supply control circuitry 208, (e.g., set the frequency, power supply output voltage, etc.). The power supply control circuit 200 applies the validation information 302, and in some implementations a portion of the configuration parameters 304, to determine whether or not to apply the configuration parameters 304 to configure the power supply control circuitry 208. That is, to determine whether the configuration information 300 is intended for use by the power supply control circuit 200. The validation information 302 is a data structure that includes validation parameters that are indicative of the power supply controller for which the configuration information 300 is intended. In various implementations of the configuration information 300, the validation information 302 may be provided as a header or a footer with respect to the configuration parameters 304.

In some implementations, the validation information 302 may include a part number 306, a part revision number 308, and/or a part address 310. The part number 306 indicates the type of power supply control circuit for which the configuration information 300 is intended by specifying a manufacturer's part number for the intended power supply control circuit. The part revision number 308 further indicates the type of power supply control circuit for which the configuration information 300 is intended by specifying a manufacturer's revision of the intended power supply control circuit identified by the part number 306.

When multiple power supply control circuits are disposed on a printed circuit board or other substrate, each of the power supply control circuits is assigned a different address to enable unicast communication to each of the power supply control circuits via the serial bus 210. The part address 310 indicates the address of the power supply control circuit for which the configuration information 300 is intended.

Some implementations of the validation information 302 may also include an external component field 312. The external component field 312 specifies that connection of the power supply components 112 to a terminal of the power supply control circuit 200 is to be verified. For example, the voltage or current present at a terminal of the power supply control circuit 200 may indicate whether a component of the power supply components 112 is connected to the power supply control circuit 200. The external component field 312 may specify that any one or more terminals of the power supply control circuit 200 be tested for an external component connection.

Each field of the validation information 302 (e.g., the part number 306, the part revision number 308, the part address 310, and the external component field 312) may include a control value 314, such as a flag, that specifies whether the test associated with the field is to be performed. For example, a test enable flag associated with the part address 310 may indicate whether or not the part address 310 is to be compared with an internal address of the power supply control circuit 200.

FIG. 4 shows a block diagram for a controller circuit 400 in accordance with the present disclosure. The controller circuit 400 is an implementation of the controller circuit 204. The controller circuit 400 receives the configuration information 300 via the serial bus 210, identifies the validation information 302 in the configuration information 300, and compares validation information 302 to identification information stored in the controller circuit 400 at manufacture or identification information derived from external connections of the power supply control circuit 200.

The controller circuit 400 includes part number verification circuitry 402, part revision verification circuitry 404, part address verification circuitry 406, external connection verification circuitry 408, and configuration validation circuitry 412. In some implementations, the part number verification circuitry 402, the part revision verification circuitry 404, the part address verification circuitry 406, the external connection verification circuitry 408, and the analog-to-digital converter 410, or portions thereof, may be implemented in a microcontroller or a state machine. A microcontroller implementation includes instructions stored in memory. The microcontroller executes the instructions to identify the fields of the validation information 302 and compare the validation information 302 to identification information stored in the power supply control circuit 200 or derived from circuitry connected to the power supply control circuit 200. A state machine implementation includes dedicated logic circuitry to identify the fields of the validation information 302 and compare the validation information 302 to identification information stored in the power supply control circuit 200 or derived from circuitry connected to the power supply control circuit 200.

The part number verification circuitry 402 is coupled to the serial communication interface 202. As the serial communication interface 202 receives the configuration information 300, the serial communication interface 202 provides the part number 306 to the controller circuit 400 and the part number verification circuitry 402. The part number 416 of the power supply control circuit 200 is stored in the non-volatile memory 206 or other non-volatile storage device at the time the power supply control circuit 200 is manufactured. The part number verification circuitry 402 retrieves the part number 416 from the non-volatile memory 206 and compares the part number 416 to the part number 306. If the part number 416 is not the same as the part number 306, then the controller circuit 400 may reject the configuration information 300 and prevent the configuration information 300 from being used to configure the power supply control circuitry 208.

As the serial communication interface 202 receives the configuration information 300, the serial communication interface 202 also provides the part revision number 308 to the controller circuit 400 and the part revision verification circuitry 404. The part revision number 420 of the power supply control circuit 200 is stored in the non-volatile memory 206 or other non-volatile storage device at the time the power supply control circuit 200 is manufactured. The part revision verification circuitry 404 retrieves the part revision number 420 from the non-volatile memory 206 and compares the part revision number 420 to the part revision number 308. If the part revision number 420 is not the same as the part revision number 308, then the controller circuit 400 may reject the configuration information 300 and prevent the configuration information 300 from being used to configure the power supply control circuitry 208.

As the serial communication interface 202 receives the configuration information 300, the serial communication interface 202 also provides the part address 310 to the controller circuit 400 and the part address verification circuitry 406. Because multiple instances of the power supply control circuit 200 may be used on a board, the address of the serial communication interface 202 may be set by connecting a terminal of the power supply control circuit 200 to a voltage source. For example, in some implementations of the power supply control circuit 200, an address is assigned to the power supply control circuit 200 by using a resistor external to the power supply control circuit 200 to set the voltage on a particular terminal of the power supply control circuit 200, where the voltage corresponds to an address. The part address 424 is determined at initialization of the power supply control circuit 200, and stored in a register of the power supply control circuit 200 (e.g., a register of the serial communication interface 202). The part number verification circuitry 402 retrieves the part address 424 from the register and compares the part address 424 to the part address 310. If the part address 424 is not the same as the part address 310, then the controller circuit 400 may reject the configuration information 300 and prevent the configuration information 300 from being used to configure the power supply control circuitry 208.

As the serial communication interface 202 receives the configuration information 300, the serial communication interface 202 also provides the external component field 312 to the controller circuit 400 and the part address verification circuitry 406. Responsive to the external component field 312, the external connection verification circuitry 408 compares the voltage (or current) 428 at one or more terminals of the power supply control circuit 200 to voltage or current values expected given use of the configuration information 300 to configure the power supply control circuitry 208. The external connection verification circuitry 408 includes an analog-to-digital converter 410 that digitizes the voltage (or current) 428 present on the one or more terminals of the power supply control circuit 200 for comparison to values expected if the configuration information 300 is used to configure the power supply control circuitry 208. For example, if the power supply control circuit 200 is a multi-phase power supply control circuit, and the configuration parameters 304 indicate that a particular phase is to be configured to drive the power supply components 112, then the external connection verification circuitry 408 may digitize the voltage or current at one or more terminals of the power supply control circuit 200 that should be connected to the power supply components 112 for the phase. The voltage(s) or current(s) at the terminal(s) indicate whether the terminals are connected to the power supply components 112. If the voltage(s) or current(s) indicate that the terminal(s) are not connected to the power supply components 112 as would be expected for application of the configuration information 300, then the controller circuit 400 may reject the configuration information 300 and prevent the configuration information 300 from being used to configure the power supply control circuitry 208. Similarly, if the voltage(s) or current(s) indicate that the terminal(s) are connected to the power supply components 112 as would not be expected for application of the configuration information 300, then the controller circuit 400 may reject the configuration information 300 and prevent the configuration information 300 from being used to configure the power supply control circuitry 208.

The configuration validation circuitry 412 receives a result 430 from the part number verification circuitry 402, a result 432 from the part revision verification circuitry 404, a result 434 from the part address verification circuitry 406, and a result 436 from the external connection verification circuitry 408. Based on the results 430-436, the configuration validation circuitry 412 determines whether the configuration information 300 is intended for use by the power supply control circuitry 208 and should be accepted and used to configure the power supply control circuitry 208, or is not intended for use by the power supply control circuitry 208 and should be rejected and not used to configure the power supply control circuitry 208. If the results 430-434 indicate that the part number 306 is the same as the part number 416, the part revision number 308 is the same as the part revision number 420, the part address 310 is the same as the part address 424, and/or the result 436 indicates that one or more terminals of the power supply control circuit 200 is connected to an external component as expected, then the configuration validation circuitry 412 may determine that the configuration information 300 is intended to be used by the power supply control circuitry 208 and activate signal 438 to accept the configuration information 300 for use in configuring the power supply control circuitry 208.

If the results 430-434 indicate that the part number 306 is not the same as the part number 416, the part revision number 308 is not the same as the part revision number 420, the part address 310 is not the same as the part address 424, or the result 436 indicates that one or more terminals of the power supply control circuit 200 is not connected to an external component as expected, then the configuration validation circuitry 412 may determine that the configuration information 300 is not intended to be used by the power supply control circuitry 208 and activate signal 438 to reject the configuration information 300 and prevent use of the configuration information 300 in configuring the power supply control circuitry 208. In some implementations, the configuration parameters 304 may not be stored in the non-volatile memory 206 if rejected. If the configuration validation circuitry 412 rejects the configuration information 300, then the configuration validation circuitry 412 may activate an alert signal 440 to communicate the rejection to circuitry external to the power supply control circuit 200.

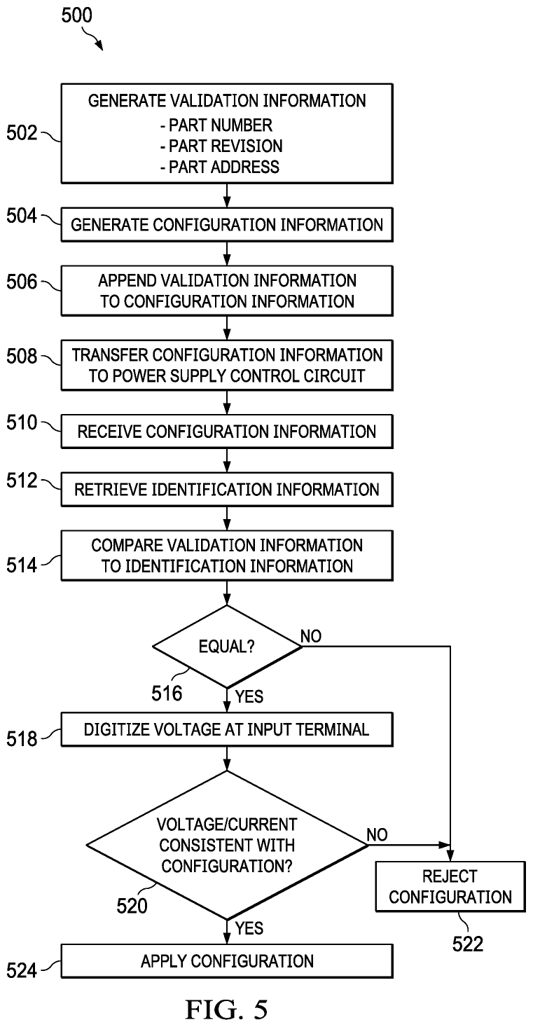

FIG. 5 shows a flow diagram for a method 500 for validating configuration information in a power supply control circuit 200 in accordance with the present disclosure. Though depicted sequentially as a matter of convenience, at least some of the actions shown can be performed in a different order and/or performed in parallel. Additionally, some implementations may perform only some of the actions shown.

In blocks 502-506, a configuration file is created. For example, a computer-based configuration tool may be provided by a manufacturer of the power supply control circuit 200, and operated by a user of the power supply control circuit 200 to generate a configuration file that contains the configuration information 300. In block 502, the validation parameter values that are to be used by the power supply control circuit 200 to determine whether the received configuration information 300 is intended for use with the power supply control circuit 200 are provided. Generation of the validation information may include providing the part number of the power supply control circuit 200 for which the configuration file is intended, providing the part revision of the power supply control circuit 200 for which the configuration file is intended, and providing the part address of the power supply control circuit 200 for which the configuration file is intended. Some implementations may also include providing an indication that connection of an external component to the power supply control circuit 200 is to be checked for consistency with the configuration parameters provided to the power supply control circuit 200. An indication of whether each of the provided validation parameters (part number, revision, address, external connection, etc.) is to be applied to validate the configuration information may also be provided. The configuration tool generates the validation information 302 based on the validation parameters provided.

In block 504, the configuration parameters that are used by the power supply control circuit 200 to configure the power supply control circuitry 208 are provided to the configuration tool. The configuration parameters may include frequency of operation of the power supply control circuit 200, output voltage of the power supply 102, maximum output current of the power supply 102 and other parameters. The configuration tool may format the entered configuration parameters 304 as needed to configure the power supply control circuit 200.

In block 506, the validation information 302 generated in block 502 is appended to the configuration parameters 304 generated in block 504. For example, the validation information 302 may be provided as a header that precedes to the configuration parameters 304 or as a footer the follows the configuration parameters 304.

In block 508, the configuration information 300 formed by appending the validation information 302 to the configuration parameters 304 is transferred to a power supply control circuit 200. For example, the power supply control circuit 200 may be mounted on a printed circuit board along with the power supply components 112 and the electronic circuitry 106. A serial bus master circuit is coupled to a computer, and the computer downloads the configuration information 300 generated in blocks 502-506 to the power supply control circuit 200 through the serial bus master circuit.

In blocks 510-514, the power supply control circuit 200 receives the configuration information 300 transmitted in block 508 and determines whether the configuration is intended for use by the power supply control circuit 200. In block 510, the power supply control circuit 200 receives the configuration information transmitted in block 508. The serial communication interface 202 converts the serial bit stream to parallel data values.

In block 512, the controller circuit 204 retrieves identification information stored in the power supply control circuit 200. For example, the part number 416 and the part revision number 420 may be retrieved from the non-volatile memory 206, and the part address 424 may be retrieved from an address register in the serial communication interface 202.

In block 514, the controller circuit 204 receives the validation information 302 from the serial communication interface 202, and compares the identification information retrieved in block 512 to the validation parameters received in the validation information 302. For example, the part number verification circuitry 402 compares the part number 306 and the part number 416, the part revision verification circuitry 404 compares the part revision number 308 and the part revision number 420, and the part address verification circuitry 406 compares the part address 310 and the part address 424. In some implementations, each validation parameter includes a flag or other indicator that specifies whether a comparison to the parameter is to be performed, and the controller circuit 204 performs each comparison as indicated by a corresponding flag.

In block 516, if the comparisons performed in block 514 indicate that the validation parameters received in the validation information 302 are not the same as the identification information retrieved in block 512, then, in block 522, the controller circuit 204 rejects the configuration information 300, and prevents use of the configuration information 300 to configure the power supply control circuitry 208.

If the comparisons performed in block 514 indicate that the validation parameters received in the validation information 302 are the same as the identification information retrieved in block 512, then, in block 518, the controller circuit 204 digitizes the voltage or current at one or more terminals (e.g., input terminals 214) of the power supply control circuit 200.

In block 520, the controller circuit 204 compares the voltage or current values acquired in block 518 to voltage or current values that are expected if the power supply components 112 are connected to the power supply control circuitry 208 in an arrangement that is consistent with the configuration of the power supply control circuitry 208 using the configuration parameters 304. If the measured voltage or current is not consistent with the voltage or current expected if the power supply components 112 are connected to the power supply control circuitry 208 in an arrangement based on configuration of the power supply control circuitry 208 using the configuration parameters 304, then the controller circuit 204 rejects the configuration information 300, and prevents use of the configuration information 300 to configure the power supply control circuitry 208, in block 522.

If the measured voltage or current is consistent with the voltage or current expected if the power supply components 112 are connected to the power supply control circuitry 208 in an arrangement based on configuration of the power supply control circuitry 208 using the configuration parameters 304, then the controller circuit 204 accepts the configuration information 300, the configuration information 300 is stored in the non-volatile memory 206, and used to configure the power supply control circuitry 208.

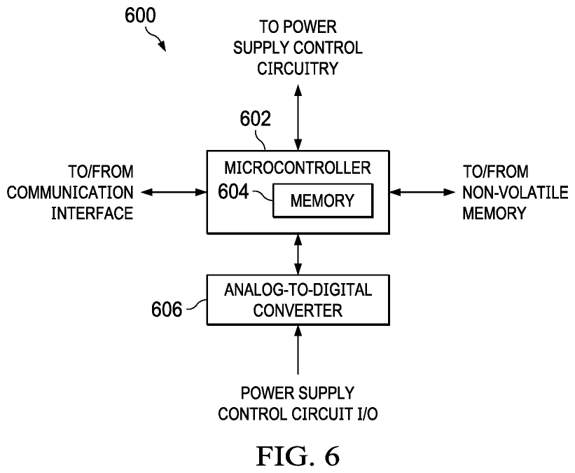

FIG. 6 shows a block diagram for an example controller circuit 600 provided in some implementations of a power supply control circuit in accordance with the present disclosure. The controller circuit 600 is an implementation of the controller circuit 204. The controller circuit 600 includes a microcontroller 602 and an analog-to-digital converter 606. In some implementations, the analog-to-digital converter 606 may be included in the microcontroller 602. The microcontroller 602 includes a memory 604 that stores instructions to be executed by a processor core of the microcontroller 602. When executed, the instructions cause the microcontroller 602 to perform the various operations disclosed herein to determine whether received configuration information is intended for use in the power supply control circuit 200. For example, instructions stored in the memory 604 may cause the microcontroller 602 to perform the operations described with respect to blocks 510-524 of the method 500.

The analog-to-digital converter 606 is coupled to the microcontroller 602 and to one or more input-output terminals of the power supply control circuitry 208. The microcontroller 602 controls and communicates with the analog-to-digital converter 606 to digitize a signal at an input terminal of the power supply control circuitry 208 and determine, based on the digitized signal, whether received configuration information is intended for use with power supply components 112 (i.e., perform the operations of blocks 518 and 520 of the method 500).

Some implementations of the 600 may include a state machine or other dedicated circuitry, rather than the microcontroller 602, configured to perform the validation operations disclosed herein.

The above discussion is meant to be illustrative of the principles and various embodiments of the present invention. Numerous variations and modifications will become apparent to those skilled in the art once the above disclosure is fully appreciated. It is intended that the following claims be interpreted to embrace all such variations and modifications.

What is claimed is:

1. A power supply control circuit, comprising:
serial communication circuitry configured to receive configuration information, wherein the configuration information comprises a data structure containing validation information identifying a power supply controller;
non-volatile memory storing:
the configuration information; and
identification information that identifies the power supply control circuit; and
a controller circuit coupled to the serial communication circuitry and the non-volatile memory, and configured to:
identify the validation information in the configuration information;
retrieve the identification information from the non-volatile memory;
compare the validation information to the identification information;
determine whether the configuration information is intended to be used by the power supply control circuit;
and
apply the configuration information to configure the power supply control circuit based on a determination that the configuration information is intended to be used by the power supply control circuit.

2. The power supply control circuit of claim 1, wherein the controller circuit is configured to compare a controller part number included in the data structure to a part number of the power supply control circuit included in the identification information.

3. The power supply control circuit of claim 1, wherein the controller circuit is configured to compare a controller revision number included in the data structure to a revision number of the power supply control circuit included in the identification information.

4. The power supply control circuit of claim 1, wherein the controller circuit is configured to compare a part address value included in the data structure to a part address of the power supply control circuit.

5. The power supply control circuit of claim 1, wherein the controller circuit is configured to compare each of a plurality of validation parameters of the validation information to an identification value of the identification information based on a control value corresponding to the validation parameter indicating that a comparison is to be performed.

6. The power supply control circuit of claim 1, further comprising:
an input terminal; and
an analog-to-digital converter configured to digitize a signal received at the input terminal;
wherein the signal is indicative of an external component connected to the power supply control circuit; and
wherein the controller circuit is configured to determine whether a configuration of the power supply control circuit based on the configuration information is consistent with the external component.

7. The power supply control circuit of claim 1, wherein the controller circuit is configured to reject the configuration information responsive to a determination that the configuration information is not intended for use in the power supply control circuit.

8. The power supply control circuit of claim 1, wherein the controller circuit is configured to activate an alert signal indicating that the configuration information is rejected responsive to a determination that the configuration information is not intended for use in the power supply control circuit.

9. A method, comprising:
receiving, by a power supply control circuit, via a serial communication interface, configuration information to configure power supply control circuitry of the power supply control circuit; wherein the configuration information comprises a data structure containing validation information that identifies a power supply controller;
retrieving, by the power supply control circuit, from non-volatile memory of the power supply control circuit, identification information stored in the power supply control circuit at manufacture;
comparing, by the power supply control circuit, the validation information to the identification information;
determining, based on a result of the comparing, whether the configuration information is intended to be used by the power supply control circuit; and
rejecting, by the power supply control circuit, the configuration information for use in the power supply control circuit based on the determining indicating that the configuration information is not intended to be used by the power supply control circuit.

10. The method of claim 9, further comprising applying the configuration information to configure the power supply control circuit responsive the determining indicating that the configuration information is intended to be used by the power supply control circuit.

11. The method of claim 9, further comprising activating an alert signal indicating that the configuration information is rejected responsive to the determining indicating that the configuration information is not intended to be used by the power supply control circuit.

12. The method of claim 9, wherein the comparing comprises comparing a controller part number included in the data structure to a part number of the power supply control circuit included in the identification information.

13. The method of claim 9, wherein the comparing comprises comparing a controller revision number included in the data structure to a revision number of the power supply control circuit included in the identification information.

14. The method of claim 9, wherein the comparing comprises comparing an address value included in the data structure to an address of the power supply control circuit.

15. The method of claim 9, further comprising comparing each of a plurality of validation parameters of the validation information to an identification value of the identification information based on a control value corresponding to the validation parameter indicating that a comparison is to be performed.

16. The method of claim 9, further comprising:
comparing a voltage or current at an input terminal of the power supply control circuit to a threshold; wherein the voltage or current is indicative of an external component connected to the power supply control circuit;
rejecting the configuration information responsive to the comparing of the voltage or current to the threshold indicating that the configuration information is not intended for use in a circuit comprising the power supply control circuit and the external component.

17. A server system comprising:
a power supply circuit configured to generate a power supply voltage, and comprising a power supply control circuit; and
server circuitry powered by the power supply circuit;
wherein the power supply control circuit comprises:
serial communication circuitry configured to receive configuration information comprising a data structure containing validation information that identifies a power supply controller corresponding to the configuration information;
non-volatile memory configured to:
store the configuration information; and
store identification information that identifies the power supply control circuit; and
a controller circuit configured to:
compare the validation information to the identification information; and
apply the configuration information to configure the power supply control circuit responsive to the comparison indicating that the power supply control circuit is the power supply controller identified by the configuration information.

18. The server system of claim 17, wherein the controller circuit is configured to:
compare a controller part number included in the data structure to a part number of the power supply control circuit included in the identification information;
compare a controller revision number included in the data structure to a revision number of the power supply control circuit included in the identification information; and
compare an address value included in the data structure to an address of the power supply control circuit.

19. The server system of claim 17, wherein the controller circuit is configured to compare each of a plurality of validation parameters of the validation information to an identification value included in the identification information based on a control value included in the data structure and corresponding to the validation parameter indicating that a comparison is to be performed.

20. The server system of claim 17, wherein the power supply control circuit comprises:
an input terminal; and
an analog-to-digital converter configured to digitize a signal received at the input terminal;
wherein the signal is indicative of a component of the power supply circuit connected to the power supply control circuit;
wherein the controller circuit is configured to determine whether the configuration information is intended for use in the server system given connection of the component to the power supply control circuit.
